(19) United States
(12) Patent Application Publication
(10) Pub. No.: US 2017/0255997 A1
(43) Pub. Date: Sep. 7, 2017

(54) Social Investing Software Platform

(71) Applicant: Isa Diane Watson, Durham, NC (US)

(72) Inventor: Isa Diane Watson, Durham, NC (US)

(21) Appl. No.: 15/057,664

(22) Filed: Mar. 1, 2016

(51) Int. Cl. G06Q 40/06

(52) U.S. Cl. CPC G06Q 40/06; G06Q 50/01

(57) ABSTRACT

The system and method of envestment is a way of providing investment opportunities having a completed action in addition to a monetary or service investment. Envestments are pushed to users or groups of users based upon challenges, groups, and friend relationships for which the user or group of users may have a high affinity, where affinity is calculated based upon each individual user's past actions modified by analysis and rules created through the use of social physics. The envested platform utilizes these data analysis techniques to enhance the user's experience and increase retention, engagement and ultimately envestments.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

Investing is often a very personal set of decisions for not only putting assets to work, but putting them to work in such a way that the investments also achieve social or societal goals that an investor finds important. Many investors utilize a social footprint, acquired through access to social networking events and websites, to make investment decisions that have a social impact as well as providing a return on investment. Investment software applications are available in today's investing environment to permit an investor to retrieve investment information from a financial institution via the internet and then select only information on investments that have a social purpose embedded in the investment.

Additionally, an investment software application may provide access to investment information through social networking websites to other members of an investor's social circle. Other software applications provide information on the review, recommendation and rating of a prospective investment that an investor may choose to share with a social circle. Still others provide an ability to establish a social network of connected individuals as an entry point for a social investment group.

In each situation, investment information is gathered and provided as guidance to individual investors who may then provide this information to groups of like-minded investors. The goal of such groups is to better leverage investment in a worthy cause by aggregating investment from a group of like-minded investors.

### BRIEF DESCRIPTION OF THE DRAWINGS

Certain illustrative embodiments illustrating organization and method of operation, together with objects and advantages may be best understood by reference to the detailed description that follows taken in conjunction with the accompanying drawings in which:

FIG. 1 is a view of a system implementation consistent with certain embodiments of the present invention.

FIG. 2 is a diagram for system functionality for the envested platform consistent with certain embodiments of the present invention.

FIG. 3 is a flow diagram for a user interaction with the envested system consistent with certain embodiments of the present invention.

FIG. 4 is a flow diagram for group operation and actions consistent with certain embodiments of the present invention.

FIG. 5 is a flow diagram challenge processing consistent with certain embodiments of the present invention.

FIG. 6 is a flow diagram for a flow diagram for locating or addition of a friend consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

Although there is a long history of investment with a social conscience in this country, utilizing social websites and social media as an aspect of determining the types of investments individuals with like mindsets, or like-minded groups of individuals, might promote to one another is not common. Those individuals who have grown up with social media and groups that span large geographic areas based on interests shared are the individuals who are believed to be those most interested in envestment, because these individuals have the capability to invest with a social purpose as a part of the investment. These individuals are far more likely to share their interest and investment in areas that provide for the common good to their social circles and groups in which they are in contact via social media. They are also far more likely to challenge others who are like-minded individuals to invest in the same cause or interest. Predicting these types of investment with a social purpose and presenting these investment opportunities to identified social groups is the process known as envesting, which is further recited in this document.

There exists a need to provide multiple generations who are, and will be, involved with social media and adept with internet access to information, a system and method for predicting and presenting investment opportunities having a component or interest in achieving a social good to individuals and/or groups who may wish to invest in the selected social good based upon discovered social interactions and interests. In an exemplary embodiment, an envestment provides individual users of the system with a personalized experience based on correlations between individual and collective activity in social interactions. The Envested platform utilizes personalized recommendations data analysis techniques to enhance the user's experience and increase retention, engagement and, ultimately, investments.

The following term definitions are presented to enhance the disclosure and understanding of the innovation set forth in this document.

Reference throughout this document to a “user” references an authenticated user of the envested platform.

Reference throughout this document to a “group” references a collection of users such as friends or social peers.

Reference throughout this document to a “Challenge” references a specific task created by a nonprofit organization. A challenge has a goal, time limit, and defined result.

Reference throughout this document to an “Impact Area” references a category defining a challenge or user targeted impact.

Reference throughout this document to an “envestment” references a completed action towards a challenge's goal having both an investment portion and an investor's Impact Area portion.

Reference throughout this document to an “Activity” references any user interaction in the envested platform. Activities may be specific actions such as viewing, liking, or sharing on social media sites, or secondary links such as time and location for an activity.

Reference throughout this document to an “affinity” references a specific relationship output from the recommendation service based on recorded activities.

Reference throughout this document to a “recommendation” references a specific outcome from the recommendation service based on recorded activities.

Reference throughout this document to “social physics” references a way of understanding human behavior based upon analysis of Big Data. Big Data is a label for large aggregations of data accumulated through operations of large groups of actors, or over extended periods of time for groups of actors.

Reference throughout this document to the “platform” references the overall technical architecture.

Third-party services upon which portions of the envested platform may depend for operational capabilities may include, but are not limited to, third-party applications that may provide platform capabilities and services such as a cloud database with integrated user management, push notifications and analytics tracking, a cloud-based payment platform, Machine Learning (ML), a cloud-based service supporting machine learning technology. Additional third-party services may be engaged to provide cloud-based service for analyzing log data in real time, and cloud-based service for analyzing crash data in real-time.

In an embodiment, the envested platform provides both current and predictive investment recommendations to users of the envested platform. The recommendation service is a collaborative filtering system, meaning that the system bases recommendations on the preferences and activity of many users. The service takes data collected on existing user behaviors and uses the collected information to determine what other user might like also. By using the behavior of a large number of users, the envested recommendation module can predict the preferred investment activities of any particular user. Additionally, as a result of the aggregation of data into impact areas, a user may broadly choose an impact area in which to envest. The system may be active to make decisions on envestment within that impact area on the user's behalf if the user has decided to envest passively in a broad impact area as opposed to being presented with, and having to choose among, specific envestments. The envested system will model the most effective envestments for the user based upon the user's profile and the profiles of similar users so as to provide the envestment with the greatest impact.

The input data can be any data collectable and/or collected by the envested platform. In a non-limiting example, this input data may be envestments made, comments, likes, posts, social media shares, challenges, and/or group actions. Input data may capture the interaction between the user and a challenge.

In this embodiment, links between challenges may be formed from input data concerning Impact Area and other non-activity related data. These links may provide information about static relationships that may be combined with user activity to build a robust response. The recommendation service may provide information on investment question such as what challenges would a particular user have interest, what users chare similar envesting goals and/or interests, what groups share similar envesting goals and/or interests, nonprofits that support a particular user's goals and interests, what interest areas apply to a particular user, what interest areas need the most support, or in what social activity particular envestments are involved. The activity and envestments made are not required to be exclusively monetary in nature and scope. The recommendation service may handle volunteer or other opportunities as required by a challenge. The recommendation service may depend on data generated on the platform. However, the recommendation service does not depend on specific components of the system in order to process the data generated. The service acts much like a black box in that the service takes input from user activity and real-time logging data, analyzing the input using constraint and relational modeling, and finally generating results in an accessible manner.

In an embodiment, the envested platform may have limits and constraints on operation. In a non-limiting example, all activity data recorded and transferred for processing by the platform must be retained in a secure manner. All activity data recorded and transferred for processing must not expose directly identifiable personal information, where such information may consist of address, email, name information or any other direct personal information associated with a user. The analysis is resource, time and CPU intensive, and is not designed as a real-time streaming service. Results may be exposed to users utilizing standard Representational State Transfer (REST) protocols. Results are made available only to the particular user of the system through the REST interface, and are unavailable to other users of the system at all times.

In an exemplary embodiment, the envested platform utilizes multiple cloud-based services for managing user envestment activity and real-time analytics. Users interact with the envested platform utilizing mobile interfaces, web client interfaces, or any user interface with a network capable device. The clients interact with the Envested platform through well-defined REST interfaces, with each service responsible for specific operations within the Envested platform. In this embodiment, the recommendation service may be implemented by the ML software component.

In this exemplary embodiment, a Machine Learning (ML) service software component processes data as an offline service. It operates within the envested platform as a standalone system component and may communicate with devices and systems external to the envested platform through an API front end capable of interfacing with external client applications. In this embodiment, the ML service is responsible for fetching user activity from the real-time services components of the envested platform, storing unique user activity data for later recall and processing, using social physics capabilities and ML processing to build affinity tables, storing the results from the affinity processing in the envested platform memory, and providing the result via the API to client applications and, subsequently, users of the system.

In an embodiment, the envested platform provides an affinity determination between users and possible investments. This affinity determination refers to the process of assigning a score based on user activity. The platform affinity determination module collects all of the actions that users perform and converts the collected information into an affinity value. This calculated affinity value expresses the affinity between users and items, where the higher the affinity score, the greater the affinity between the user and a given item.

In this embodiment, affinity scores may be developed for a number of interactions. Affinities such as user-to-user, user-to-group, user-to-challenge, and group-to-challenge are examples of affinities for which scores may be developed by the affinity determination algorithm, however, this list should in no way be considered exhaustive of all affinity types that may be generated. In a non-limiting example, the user-to-user or user-to-group affinity score may be a result of user-to-user and user-to-group interactions and may guide how friends or groups are recommended to any particular user. Actions each have a assigned value to each action, such as, by way of example, envesting in the same challenge as another user, adding or inviting a user as a friend, or viewing users, groups, or challenges associated with another user. The assigned values of each action are accumulated and an affinity score developed from the accumulated values. The affinity score may not be a strictly numerical value, but instead, may be expressed as a relative difference from other measurements of value provided by the system. The fact that the affinity score is represented as a numerical value should in no way be considered limiting, as the affinity valuation may change from implementation to implementation based upon increased understanding of the measurements and assignments of affinity developed by the system. In each case, the affinity score will be a measure of relative difference from one envestment to another based upon the user interests and desired impact areas. The affinity score is assigned to a user and an item as a pair, providing an ability to analyze the score to determine whether a recommendation about a particular user or item should be presented to a first user.

In an additional embodiment, a user-to-challenge or group-to-challenge affinity score may be developed as a result of user-to-challenge and group-to-challenge interactions and may later guide how friends or groups are recommended to any given user. As in the user-to-user and user-to-group example, the envested platform may collect envesting actions by a user such as responding as an individual to an investment challenge or responding as a part of a group to and investment challenge, or viewing challenges. Each action is associated with a worth score for that particular activity. The worth score may not be a strictly numerical value, but instead, may be expressed as a relative difference from other measurements of worth provided by the system. The fact that the worth score is represented as a numerical value should in no way be considered limiting, as the valuation may change from implementation to implementation based upon increased understanding of the measurements and assignments of worth developed by the system. In each case, the worth score will be a measure of relative difference from one envestment to another based upon the user interests and desired impact areas. The worth scores are collected and a total worth score developed from the accumulated values. The worth score is assigned to a user or group against particular challenges and the worth score used to determine whether a particular challenge or nonprofit is presented to a particular user.

In an exemplary embodiment, envestment recommendations, which are recommendations of users, groups, challenges, or non-profit investment opportunities a particular user may choose to follow or select for action, are based upon the affinity models developed above. The envestment platform may provide recommendations to users based upon the affinity to recommendation as defined and outlined in social physics and typical data analysis methods. In a non-limiting example, recommending a challenge to a user might be through the process of determining the affinity score associated with each challenge and that user, and returning the challenges with the highest affinity scores for recommendation to the user.

In this embodiment, the recommendation service may run all tasks on a pre-determined schedule. ML processing is computationally expensive. For this reason, the ML processing will be run on computer systems dedicated to the ML processing tasks and controlled via a scheduler to ensure there are no interruptions to the tasks and to limit exposure to outside influences. In this manner, the cost of performing the ML processing tasks may be controlled and minimized.

The envestment platform may also provide a prediction and rating service that combines challenge activity with user activity to determine successful challenges, and the relative rate of success of challenges defined in the system. In a non-limiting embodiment, the prediction and rating service may answer questions such as, did the challenge meet the desired goal, and what percentage of the desired goal was met; how many comments, likes and/or shares the challenge and envestments in the challenge received; how many individuals and groups envested in the challenge; how many groups added the challenge to their group; were there any repeat envestments; and in what category was the challenge placed and how did it relate to other challenges in that category. These questions may all be answered by activity recorded in the envestment platform. When the answers to the previous questions are combined with static attributes of a challenge, including, but not limited to, duration, goal, description or image, the envestment platform may create correlations between the challenge attributes and the likelihood of success of any given challenge.

In an embodiment, the prediction engine of the envested platform may utilize envestment data, including, in a non-limiting example, affinity scores, combined with static attributes for a challenge to offer to a user a success rate that is attractive to that particular user. In a non-limiting example, an investment challenge that has a picture or photo associated with the challenge has a much higher rate of success in reaching the investment goal determined for the challenge. The prediction engine may incorporate this data and provide recommendations to a user, or rate the chance of meeting the full investment goal for the challenge. A nonprofit issuing the challenge, for example, would be able to review this information about the higher success rates for challenges including a pictorial representation and alter the input associated with their challenge to include an image or other pictorial representation.

In an alternative non-limiting example, a challenge may user text or image analysis to offer better options for investment to users. If a challenge description includes offering backpacks to low income children, this challenge information could suggest that the challenge should use an image with children getting on a bus. This image suggestion would be determined from an analysis of the success of past challenges.

These results are generated from both the challenge activity, such as, for example, the percentage goal met, the description text, and the duration among other parameters, and the user activity, such as, for example, how much the user envested, how quickly the user envested, among other parameters of envestment activity. An analysis of these results may help to determine the best scenario for creating a successful challenge. The challenge prediction service is built on the same Envestment platform architecture as the recommendation service previously disclosed.

In an embodiment, a system and method for personalized envestment is disclosed having a server in communication with a network capable device, such as, but not limited to, a mobile device, a network computer, a tablet, or any other network capable device associated with a user, a plurality of software modules operative on the network capable device to collect user interaction data and communicate the collected user interaction data to the server, receive and aggregate the user interaction data into a digital database, analyzing the aggregated user interaction data to determine envestment challenges, and presenting envestment challenges predicted to be of interest to a user or to a group of users. Each user may be permitted to select one or more envestment challenges for further user action. In this embodiment, the user interaction data may consist of user preference, interest, and impact area selections, with the selections saved in a digital database implemented in a cloud-based data storage implementation.

In a non-limiting embodiment, the system and method may calculate an envestment challenge affinity value where the envestment challenge affinity value is calculated by determining a strength of affinity between a user and an impact area, interest, or user preference, ranked in order of greatest affinity to least affinity and presented to the user if the envestment challenge affinity value is above a pre-determined threshold. The envestment challenges may be associated with a friend or colleague of a user and presented to a user if an affinity value between the friend or colleague of the user and the user is above a pre-determined threshold. Additionally, a user may select one or more particular impact areas for investigation on envestment.

In an embodiment, the system and method may associate a user with one or more groups of users. One user of a group may transmit one or more challenges to other members of the group, where envestment challenges are presented to users and groups of users based upon impact areas that are associated with user interests, or where impact areas are preselected by each user. In this embodiment, further action on a selected challenge may include any of monetary investment, time investment, trade-in-kind, or promises to perform actions in support of challenge fulfillment.

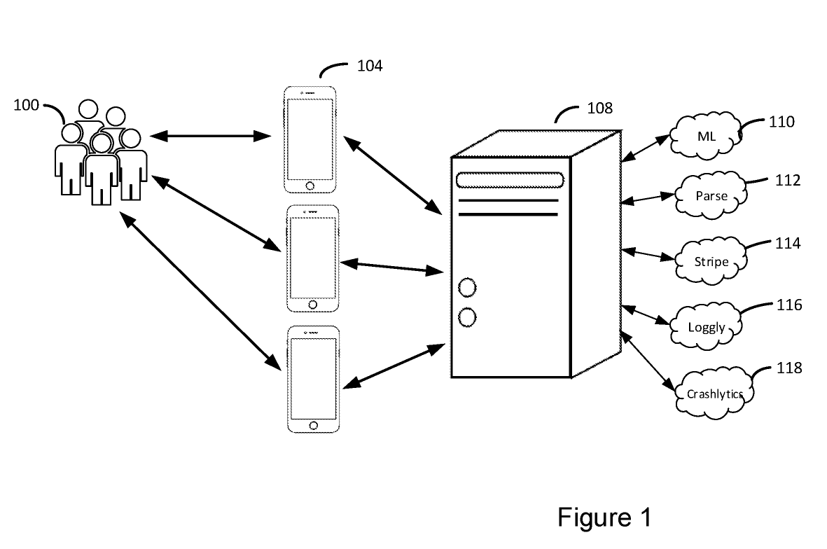

Turning now to FIG. 1, this figure presents a view of an exemplary system configuration consistent with certain embodiments of the present invention. In an exemplary embodiment, each user 100 may utilize a mobile device 104 such as, in a non-limiting example, a smart phone, tablet, internet computer, or other mobile processing device, to contact the envested master server 108. The mobile device 104 may have an application or client software that has been downloaded from the master server 108 when each user 100 joined the envestment social community. The master server 108 may serve as the central repository for all data records, user records, tracking data, and analysis software for the system. The mobile device 104 permits each user 100 to connect to and exchange information with the master server 108. The information exchange may include retrieving and transmitting data regarding envestments, challenges, social interactions with other users and groups of users, and predictive recommendations for each user 100, among other data and analysis services.

The envestment service is both a social community platform and a management platform, managing interactions between users 100 and groups of users through a suite of software applications that are both best of class and custom designed and built for the system. In this exemplary embodiment, the suite of software modules installed and operating in the master server 108 may be active to provide services in support of the system capabilities and interaction with each user 100. By way of example and not of limitation, the master server 108 may have a Machine Learning (ML) software module 110 such as Amazon ML to support learning technology. The ML software module 110 may be operative to learn about the user 100 while each user is interacting with the system so as to analyze user 100 activity to create relationship and interest data files for each user 100 so as to provide users with a personalized experience based on correlations between individual and collective activity on the envested platform.

In this exemplary embodiment, the master server 108 may also have additional third-party software modules integrated into the envested platform to perform specific tasks necessary to the continuous operation of the envested platform. Once again, by way of example and not of limitation, the master server 108 may have installed a software module having a cloud-based database that is responsible for integrating the management of the user interaction and experience, provide push notifications to each user 100, and create and track analytics for users and groups of users. In a non-limiting example, one such third party software module providing these services may be Parse 112, although other software modules may provide all or portions of these services as well instead of, or in addition to, the functionality provided by the Parse application 112. The master server 108 may also have a software module that implements a cloud based payment capability. Once such third party software module that serves as a cloud based payment platform is Stripe 114, although, once again, other third party software modules may provide all or portions of the functionality provided by the Stripe application 114.

In this exemplary embodiment, additional third party software modules, such as Loggly 116 may be integrated into the envested platform to provide cloud based service for analyzing log data in real-time, and Crashlytics 118 may be integrated into the envested platform to provide cloud based service for analyzing crash data in real-time. Each of these service providers may provide all or portions of the functionality for log data analysis and crash data collection, analysis and reporting, however, other service providers may be integrated in future versions of the envested platform with no change to the process and service provided to users and groups of users by the envested platform and must, therefore, in no way be considered limiting.

It is understood that multiple users 100 will interact with the master server 108 to be involved with the envested community and to participate in groups and challenges monitored, tracked, and managed by the master server 108. In this manner the master server 108 may foster interaction and communication between all users that have expressed interest in similar types of investments. The interaction between users in individual challenges and group challenges for envestments are also tracked and managed by the master server 108. The master server 108 may also communicate with nonprofits, foundations, social investment groups, and financial investment groups to track and manage financial investments placed with the nonprofit, foundations, social investment groups, and financial investment groups, among other beneficiaries of the envestment platform. In this manner, the master server 108 may foster financial investments having a social good component, as well as provide all users 100 of the system with an awareness and opportunity to invest in other opportunities that meet the user's interest based upon past user activity.

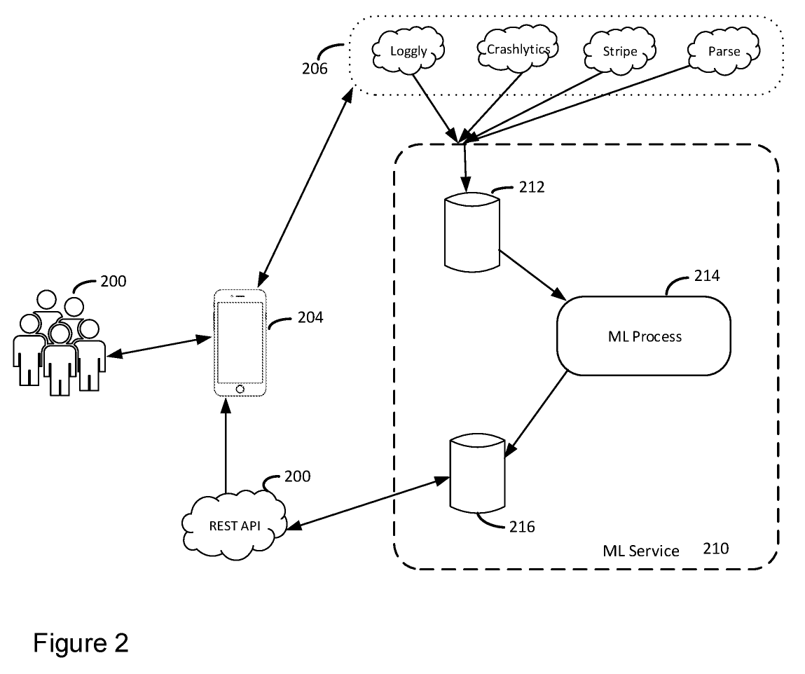

Turning now to FIG. 2, this figure presents a system diagram for system functionality for the envested platform consistent with certain embodiments of the present invention. In an exemplary embodiment, after logging in to the system, a user 200 may be presented with a recommendation display screen presented on the screen display of a mobile device 204. The user 200 may initiate the recommendation client application by selecting the action icon on the display screen.

In an exemplary embodiment, the envested platform utilizes multiple cloud-based services for managing user envestment activity, data management, real-time crash and logging activity, and real-time analytics 206, as previously described. Although the mobile web service application is presented in this figure, users 200 may interact with the envested platform utilizing mobile or web client interfaces. The clients interact with the Envested platform through well-defined REST interfaces 210, with each service responsible for specific operations within the Envested platform.

In this exemplary embodiment, the ML service 210 may serve as the central collection point for all user interaction and all system performance data. The third-party cloud-based services 206 may provide data to an actions database 212 maintained in electronic storage on the envested master server. The information collected from the real-time activities of the third-party services 206 may include all interaction data between each third-party service 206 and each user 200 of the system, as well as data that is important to the continued function of the envested experience presented to each user and group of users on the mobile device display 204. A ML process 214 operating in the ML service 210 is active to apply affinity and recommendation rules as established for the envested system. Affinity scores are calculated for each investment opportunity, each group and group challenge, and user as a friend. Affinity scores are based on specific relationship output from the recommendation service based on recorded activities and process from the incoming activity and usage information stored in the actions database 212.

In this embodiment, the ML process 214 may utilize the aggregated information stored in the actions database 212 and the calculated affinity scores to create recommendations for each user of the envested system. Recommendations are created based upon pre-established recommendation rules and updated periodically to reflect challenges and changes in the types of recommendations that are important to the user population. Once the ML process 214 has completed calculating affinity scores and determining recommendations, these data values are stored in the recommendation database 216. These recommendations are then pushed out to each user 200 from the ML service 210 through the action of the REST API between the ML service 210 and the device 204, either mobile device or web-connected device, associated with each user 200.

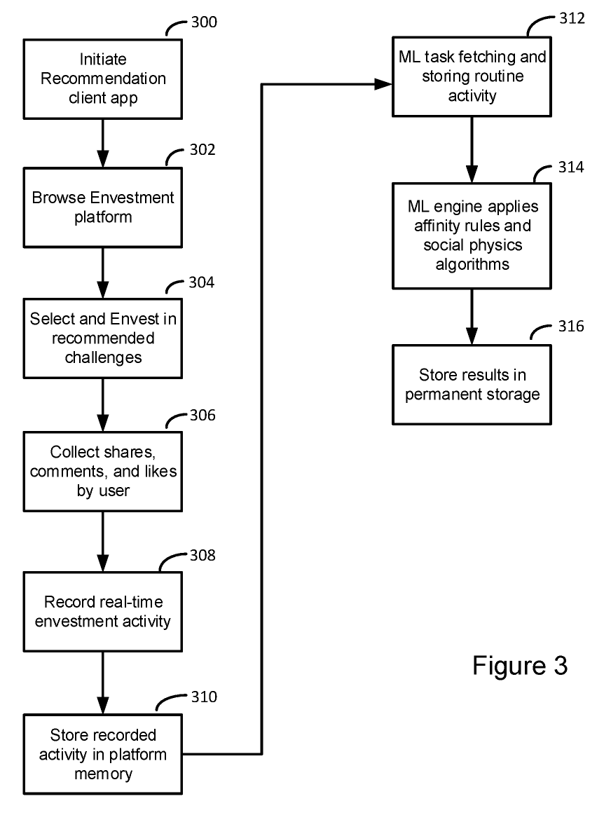

Turning now to FIG. 3, this figure presents a user interaction with the envested system consistent with certain embodiments of the present invention. In an exemplary embodiment, at 300 a user may access and initiate an envested application that has been previously downloaded to a mobile device or web enabled device associated with the user. The application may be initiated either as a mobile application for display on a mobile device, or as a web page accessed application on a web enabled device. The user may be presented with a login screen into which the user may present login credentials to access the envested application on the mobile or web enabled device. At 302 the envested application may present a screen inviting the user to browse the envestment platform actions and capabilities. At 304, challenges may be pushed out to the user. The challenges may be presented to the user as individual challenges, as group challenges, or as challenges from a friend. The challenges may be sorted on an affinity score using activity and search history of the user and activity or cause for the challenge presented. By way of illustration and not of limitation, challenge areas may be presented for areas such as education, the environment, health care, and animal welfare, as well as, at a more granular level, STEM education, arts and music, literacy, and the like.

In this exemplary embodiment, at 306, the user activity while browsing and interacting with the envested application are collected by the system and stored in an activity database. Action such as shares, comments and likes by the user are collected by the system. At 308, these actions as well as browsing data, envestment actions, friend requests, and other actions by the user are collected and recorded as latent data for each user. At 310, all recorded activity is stored in a database on the envested platform and later utilized by an affinity and recommendation module to create, update, and manage the recommendations for challenges, groups, and friend notifications for each user.

At 312, the ML engine initiates a task to fetch data associated with each user's activity within the envested platform. Data that has changed for any user is updated and stored back to the database folder or file associated with that user. At 314 the ML engine applies affinity rules with embedded social physics considerations to create affinity scores. As previously disclosed, affinity is the process of assigning a score based upon user activity within the envested platform. In a non-limiting example, user-to-user affinity scores, which may guide the manner in which friends or groups are recommended to one another, may be based on data collected and valued in the following table:

TABLE 1

| Action | Description | Value |
|---|---|---|
| Envesting | Envesting in same | 0.75 |
| | challenge as another user | |
| Friending | Adding a user as a friend | 1.0 |
| | (Approved) | |
| Friending | Adding a user as a friend | 0.5 |
| | (not approved) | |
| Viewing | Viewing a user | 0.5 |
| Viewing | Viewing a group | 0.25 |
| | containing a user | |
| Viewing | Viewing challenges in | 0.25 |
| | which a user has envested | |

In a non-limiting example, user-to-group affinity scores, which may guide the manner in which friends or groups are recommended to other groups, may be based on data collected and valued in the following table:

TABLE 2

| Action | Description | Value |
|---|---|---|
| Envesting | Envesting in the same | 0.75 |
| | challenge as a group | |
| Grouping | Adding yourself to a group | 1.0 |
| | (approved) | |
| Grouping | Requesting to be added to | 0.5 |
| | a group (not approved) | |
| Viewing | Viewing a group | 0.5 |
| Viewing | Viewing a user's groups | 0.25 |
| Viewing | Viewing challenges in | 0.25 |
| | which a group has | |
| | envested | |

In a non-limiting example, user-to-challenge affinity scores, which may guide the manner in which challenges or nonprofits are recommended for users, may be based on data collected and valued in the following table:

TABLE 3

| Action | Description | Value |
|---|---|---|
| Envesting | Envesting as an individual | 1.0 |
| | to a challenge | |
| Envesting | Envesting as part of a | 0.75 |
| | group to a challenge | |
| Viewing | Viewing a challenge | 0.5 |

In a non-limiting example, group-to-challenge affinity scores, which may guide the manner in which challenges or nonprofits are recommended for users, may be based on data collected and valued in the following table:

TABLE 4

| Action | Description | Value |
|---|---|---|
| Envesting | Envesting as an individual | 1.0 |
| | to a challenge | |
| Envesting | Envesting as part of a | 0.75 |
| | group to a challenge | |
| Viewing | Viewing a challenge | 0.5 |

The tables and affinity values as presented are simply examples of some of the scoring weights that may be assigned to various actions taken within the envested platform and should in no way be considered limiting. Addition actions, with associated values may be added or assigned at any time to better define and calculate affinity scores.

At 314, the calculation of an affinity score for any group, challenge, or friend request is the accumulation of all of the values for all activities undertaken within the envested platform by each user, modified in accordance with social weighting algorithms embedded in the envested platform. At 316, the result of the affinity calculation for each group, challenge, and friend request is stored in the database for each user. Recommendations created from the affinity scores, based upon rules embedded in the envested platform, are presented to each user sorted by the affinity score associated with the recommendation.

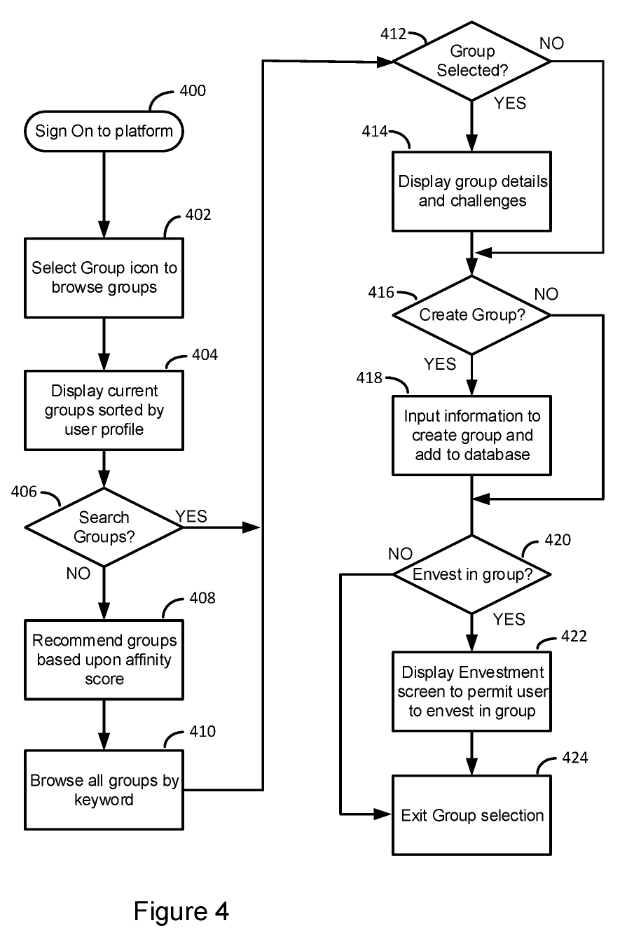

Turning now to FIG. 4, this figure presents a flow diagram for group operation and actions consistent with certain embodiments of the present invention. In an exemplary embodiment, at 400 a user may sign on to the envested platform by entering their envested credentials. At 402 the user is presented with a group icon, and upon selection of the icon the user is presented with a list of groups available for browsing. At 404, the list of groups may be sorted based upon each user's profile selections for categories and subcategories of interest associated with the user.

In an exemplary embodiment, the user may choose to search all groups to locate a group for a particular interest at 406. The search function presents results for all groups sorted based on the user's profile selections for interest category and subcategory. If the user chooses not to search for a group or groups, at 408 the user may receive a group push from the envested platform that presents the user with a notification for the group that has the highest affinity score for the user as a recommended group the user may like to consider for further action. At 410, the user may browse all groups based upon recommendations from the envested platform. The group recommendations may be based upon an affinity score using activity and search history of the groups and the user. In a non-limiting example, the envested platform may recommend groups that have made similar envestments or have related cause history to that of the user. These recommended groups may be pushed to the user periodically throughout the interaction with the group processing portion of the envested platform.

At 412, the user may select a group from a list of recommended groups through which the user has been browsing, or the group may be selected as the result of a user search of all groups. At 414, upon the selection of a group the envested platform may present the user with a display of group details and challenges that are active for that particular group. At 416, the user may be presented with the option to create a new group. At 418, if the user has elected to create a new group, the user will be presented with one or more input screens to create the new group and add this group to the database of groups managed by the envested platform. Should the user not elect to create a new group, at 420 the user may instead be presented with the option to envest in a selected group. At 422, if the user chooses to envest in the interest or challenge presented by the group, a user is presented with the envestment screen display to permit the user to enter the payment and other detailed information required to envest. At 424, if the user has chosen not to invest or if the envestment processing action is complete, the user may choose to exit the group processing portion of the envestment application.

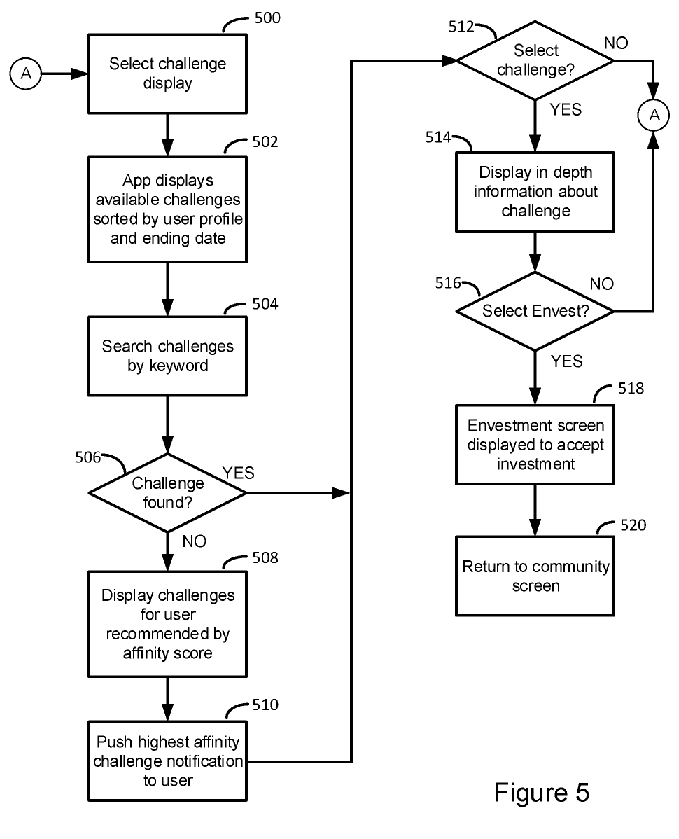

Turning now to FIG. 5, this figure presents a flow diagram for challenge processing consistent with certain embodiments of the present invention. In this exemplary embodiment, at 500 a challenge display screen may be presented to a user who may then select to begin the challenge process portion of the envested platform. At 502, upon selection, the user is presented with a display of all available challenges and the user is permitted to browse the challenges presented. Challenge results are sorted based upon the user's profile selections for interest category and subcategory, and further sorted by the ending date, with those that are ending sooner placed at the highest priority positions in the list of challenges. At 504, the user is instead permitted to search challenges available by keyword associated with each challenge. The results of the keyword search is a list of challenges sorted based upon the user's profile selections for interest category and subcategory, and further sorted by the ending date of the challenge, with those that are ending sooner placed at the highest priority positions in the list of challenges. At 506, the system checks to see if the user has found a challenge in which they have an interest. If the user has not found a challenge of interest in the sorted list created by the search, at 508 the user may instead be presented with a display of challenges that have been recommended for the user based upon affinity score between the challenge and the user. Also, as a portion of this challenge process and periodically throughout the challenge selection process, the system may push a notification to the user containing information about the challenge having the highest affinity with the user's interests at 510. In each instance, the recommended challenges are based on an affinity score using activity and search history of the user, and the activity or cause for which the challenge has been created.

At 512, the user may select a challenge, either as the result of a search or from the list of challenges presented as having an affinity with the user's interests. If the user chooses not to select a challenge, the user may be presented once again with the select challenge display at 500. If, however, the user does select a challenge, at 514 additional information about the challenge may be presented to the user for their further consideration. At 516, the user may be given the option to envest in the challenge. If the user chooses not to envest in the selected challenge, the user may be returned to the select challenge display at 500. If, however, the user chooses to envest, at 518 the user will be presented with the envestment screen display to accept the envestment and begin the process of allocating funds and/or other property or services to secure the envestment. In an exemplary embodiment, activity and envestments made in the challenge are not required to be exclusively monetary. A user may invest through contributing volunteer or other opportunities in exchange based upon the requirements of the challenge selected. At 520, the user has completed the challenge activity and may be returned to a community screen to access additional portions of the envested platform.

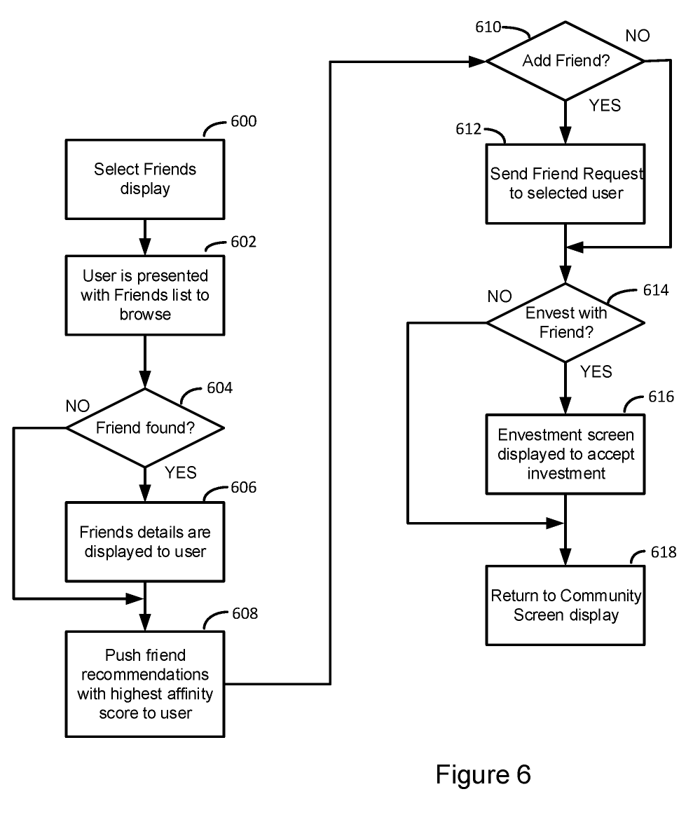

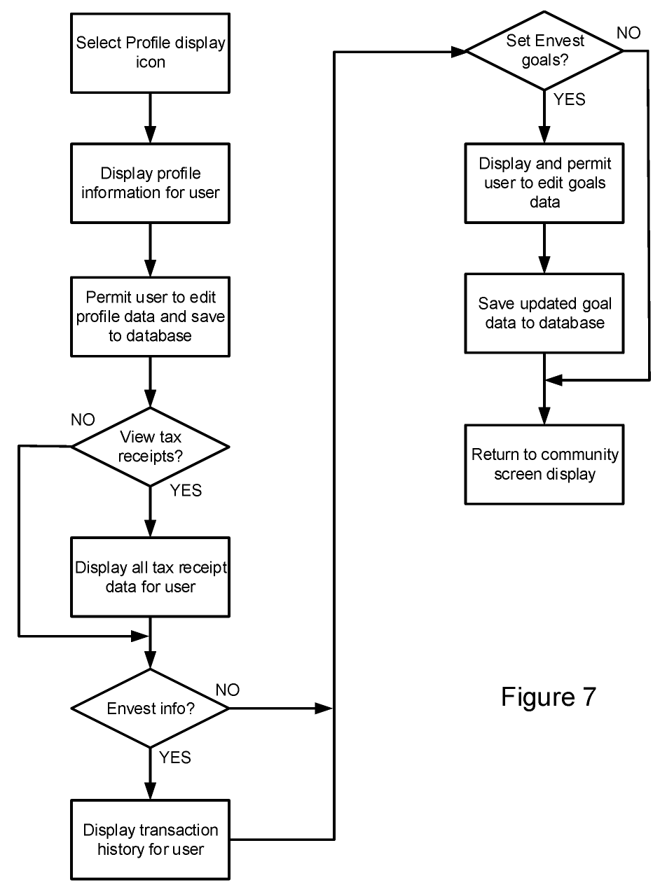

Turning now to FIG. 6, this figure presents a flow diagram for locating or addition of a friend consistent with certain embodiments of the present invention. In this exemplary embodiment, at 600 a user may be presented with a friend processing screen on the display of the mobile device or a web enabled device serving as the communication interface for the user. In this exemplary embodiment, at 602 the user may be presented with a list of friends that are associated with the user in the envestment platform database to browse. Friends are presented in the browse list based on recommendation. The recommendations are based on an affinity score using activity and search history of all users associated with the envested platform. At 604, the user may also search for a friend using keywords associated with friends of the user. If the friend is located by the system, at 606 all of the details for the friend that are maintained by the envested platform are displayed to the user. At 608, whether the friend is located or not, the system may push friend notifications to the user. The recommendations will be presented to the user based upon the affinity of each person to the user, with the list of possible friends sorted such that individuals with the highest affinity score with the user are presented at the top of the list.

In this exemplary embodiment, at 610 the user may select an individual to become a friend within the envested platform. At 612, if the user elects to friend an individual, the system will send a friend request to one or more individuals identified by the user. At 614, regardless of whether the individual selected by the user is an established friend or a new friend, the user may elect to envest in interests and challenges that are associated with the friend. If the user elects to envest with the identified friend, at 616 the envestment screen is displayed for the user to accept the envestment and begin the process of allocating funds and/or other property or services to secure the envestment. At 618, after completing an envestment, or after completing the navigation of the friend portion of the envestment platform, the user may be presented with the community screen display to access additional portions of the envested platform.

While certain illustrative embodiments have been described, it is evident that many alternatives, modifications, permutations and variations will become apparent to those skilled in the art in light of the foregoing description.

What is claimed is:

1. A system for personalized envestment, comprising:
a server in communication with a network capable device associated with a user;
a software module operative on the network capable device to collect user interaction data and communicate the collected user interaction data to the server;
a software module operative on the server to receive and aggregate the user interaction data into a digital database;
a software module for analyzing the aggregated user interaction data to determine envestment challenges; and
a software module operative to present envestment challenges predicted to be of interest to a user or to a group of users, and permitting the selection of one or more envestment challenges for further user action.

2. The system of claim 1, where the user interaction data comprises user preference, interest, and impact area selections.

3. The system of claim 1, where the digital database is implemented in a cloud-based data storage implementation.

4. The system of claim 1, further comprising calculating an envestment challenge affinity value where the envestment challenge affinity value is calculated by determining a strength of affinity between a user and an impact area, interest, or user preference, ranked in order of greatest affinity to least affinity and presented to the user if the envestment challenge affinity value is above a pre-determined threshold.

5. The system of claim 1, where the envestment challenges are associated with a friend or colleague of a user and presented to a user if an affinity value between the friend or colleague of the user and the user is above a pre-determined threshold.

6. The system of claim 1, where a user may select one or more particular impact areas for investigation on envestment.

7. The system of claim 1, further comprising associating a user with one or more groups of users.

8. The system of claim 7, where one user of a group may transmit one or more challenges to other members of the group.

9. The system of claim 1, where envestment challenges are presented to users and groups of users based upon impact areas that are associated with user interests, or where impact areas are preselected by each user.

10. The system of claim 1, where further action on a selected challenge may include any of monetary investment, time investment, trade-in-kind, or promises to perform actions in support of challenge fulfillment.

11. A method for personalized envestment, comprising:
interacting with a network capable device to input user interaction data;
collecting the input user interaction data and communicating the collected user interaction data to a server;
receiving and aggregating on the server the user interaction data and storing the user interaction data into a digital database;
analyzing the aggregated user interaction data to determine envestment challenges; and
presenting envestment challenges predicted to be of interest to a user or to a group of users, and permitting the selection of one or more envestment challenges for further user action.

12. The method of claim 11, where the user interaction data comprises user preference, interest, and impact area selections.

13. The method of claim 11, where the digital database is implemented in a cloud-based data storage implementation.

14. The method of claim 11, further comprising calculating an envestment challenge affinity value where the envestment challenge affinity value is calculated by determining a strength of affinity between a user and an impact area, interest, or user preference, ranked in order of greatest affinity to least affinity and presented to the user if the envestment challenge affinity value is above a pre-determined threshold.

15. The method of claim 11, where the envestment challenges are associated with a friend or colleague of a user and presented to a user if an affinity value between the friend or colleague of the user and the user is above a pre-determined threshold.

16. The method of claim 11, where a user may select one or more particular impact areas for investigation on envestment.

17. The method of claim 11, further comprising associating a user with one or more groups of users.

18. The method of claim 17, where one user of a group may transmit one or more challenges to other members of the group.

19. The method of claim 11, where envestment challenges are presented to users and groups of users based upon impact areas that are associated with user interests, or where impact areas are preselected by each user.

20. The method of claim 11, where further action on a selected challenge may include any of monetary investment, time investment, trade-in-kind, or promises to perform actions in support of challenge fulfillment.
